(19) United States
(12) Patent Application Publication
(10) Pub. No.: US 2008/0183114 A1
(43) Pub. Date: Jul. 31, 2008

(54) Massage Apparatus

(76) Inventor: Sung-Sik Kim, Gyeonggi-Do (KR)

Correspondence Address: IPLA P.A., 3580 WILSHIRE BLVD., 17TH FLOOR, LOS ANGELES, CA, 90010, US

(21) Appl. No.: 11/997,017

(22) PCT Filed: Jul. 21, 2006
(86) PCT No.: PCT/KR06/02868

§ 371 Date: Jan. 28, 2008

(30) Foreign Application Priority Data
Jul. 28, 2005 (KR) 10-2005-0068938

(51) Int. Cl. A61H 7/00

(52) U.S. Cl. 601/99

(57) ABSTRACT

The invention relates to a massage apparatus, a user can simply use the massage apparatus in a public space, such as a gym, or at home, while wearing clothes, because a pressing part itself, which gets in contact with a part to be massaged, does not rotate, but moves along a circle, and the cloth is not twisted, the massage apparatus can effectively massage a wide area of the human body. Further, because the massage apparatus rubs a part to be massaged while maintaining warmth of the pressing part by an electric heater, if the stomach is given a heating massage, the blood circulation is improved and the fat of the stomach can be removed. Furthermore, the intestinal motion is activated, thereby healing constipation. In addition, according to an embodiment of the invention, the main body and the pressing part are supported by a movable supporting means, such that a user can easily control the pressing force against the part to be massaged, such as the stomach etc, without excessively pressing on the stomach.

### TECHNICAL FIELD

The present invention relates to a massage apparatus, and more particularly to a massage apparatus that gives massage effect to the stomach, back, or waist by rubbing.

### BACKGROUND ART

In the related art, a hitting-type massage apparatus that hits at the target and a vibrating-type massage apparatus that vibrates under pressure are known as massage apparatuses, in particular, stomach massage apparatuses intended for massaging the stomach.

Since the above-mentioned hitting-type and vibrating type massage apparatuses give continuous massages by applying hitting or vibrating motion to only a specific contacting part, a user may feel pain in the massaged parts, especially in the bones, when the hitting or vibration is excessive.

Accordingly, in the related art, a cam-type stomach massage apparatus that presses and rubs the stomach has been developed to overcome the above problems, in which an inclined cam is connected to a driving shaft and rotated, and as the inclined cam rotates, a pressing plate rotating at an angle massages the stomach.

### DISCLOSURE OF INVENTION

### Technical Problem

According to the above-mentioned cam-type stomach massage apparatus, however, because the pressing plate itself rotates, the article of clothing is twisted in the rotational direction of the pressing plate. Accordingly, a user wearing clothing cannot receive a massage, and continuous massages are given only to a specific part in the region where the cam rotates as the hitting-type and vibrating-type massage apparatuses, such that it is difficult to effectively give a massage.

The invention has been finalized in order to solve the above problems, and it is an object of the invention to provide a massage apparatus that is capable of effectively massaging a user wearing clothing and widely massages a wide region without a pain in the specific part.

### Technical Solution

In order to accomplish the above objects, according to an aspect of the invention, a massage apparatus includes a main body including a motor, a supporting means movably supporting the main body, a pressing part mounted under the main body to get in contact with a part of a human body to be massaged, an eccentric-rotating means connected with a driving shaft of the motor to eccentrically rotate a connecting shaft connected with the pressing part, and a connecting part connecting the connecting shafts of the eccentric-rotating means to the upper portion of the pressing part such that the connecting shafts run idle.

According to the aspect of the invention, the connecting shafts may be provided in a pair, and the eccentric-rotating means may include a driving gear fitted to the driving shaft of the motor, a pair of driven gears that are engaged with the driving gear so as to face each other and have the same teeth and diameter, a pair of fixing shafts rotatably fixing the pair of driven gears under the main body, respectively, and a pair of connecting parts fitting the connecting shafts at each eccentric position relative to the fixing shafts of the respective driven gears.

According to another aspect of the invention, the eccentric-rotating means may include a crank arm whose one end is connected to the driving shaft of the motor and a pair of connecting parts connecting the connecting shafts to the other end of the crank arm, respectively.

According to another aspect of the invention, the connecting shaft is provided in a pair, the main body may include a pair of motors, and the eccentric-rotating means may include a pair of driving gears that are fitted to driving shafts of the motors, respectively, and have the same teeth and diameter, a time belt engaged with the driving gears so as to be linked with each other, and a pair of connecting parts fitting the connecting shafts to the respective driving gears at each eccentric position relative to the driving shafts of the motors.

### ADVANTAGEOUS EFFECTS

According to a stomach heating massage apparatus of the invention, a pressing part that gets in contact with a part to be massaged does not rotate and moves in a circle, such that a user wearing clothing can simply use the massage apparatus in a public place, such as a gym, or at home, as the clothing is not twisted, thereby giving an effective massage, and increasing the massage region.

According to an embodiment of the invention, since a pressing part rubs the part to be massaged while keeping warmth of the pressing part by an electric heater, when the stomach is massaged, the blood circulation is improved and the fat of the stomach can be removed. Furthermore, the intestinal motion is activated, thus healing constipation.

Further, according to another embodiment of the invention, because a main body and a pressing part are supported by a movable supporting means, a user can easily control the pressing force against the part to be massaged, such as the stomach, etc., without applying excessive pressing on the stomach by oneself.

### BRIEF DESCRIPTION OF THE DRAWINGS

FIG. 1 is a perspective view of a massage apparatus according to a preferred embodiment of the invention;

FIG. 2 is a cross-sectional view of the internal structure of a main body and pressing part of FIG. 1;

FIG. 3 is a cross-sectional view of FIG. 2 after the pressing part moves;

FIG. 4 is a cross-sectional view taken along a line AA of FIG. 2;

FIGS. 5 to 7 are views of FIG. 4 after the pressing part moves;

FIG. 8 is a cross-sectional view of the internal structure of a main body, eccentric-rotating means, and pressing part of a massage apparatus according to another embodiment of the invention;

FIG. 9 is a cross-sectional view taken along a line BB of FIG. 8;

FIG. 10 is a cross-sectional view of the internal structure of a main body, eccentric-rotating means, and pressing part of a massage apparatus according to another embodiment of the invention; and

FIG. 11 is a cross-sectional view taken along a line CC of FIG. 10.

### MODE FOR THE INVENTION

Preferred embodiments of the invention are described hereafter with reference to the accompanying drawings.

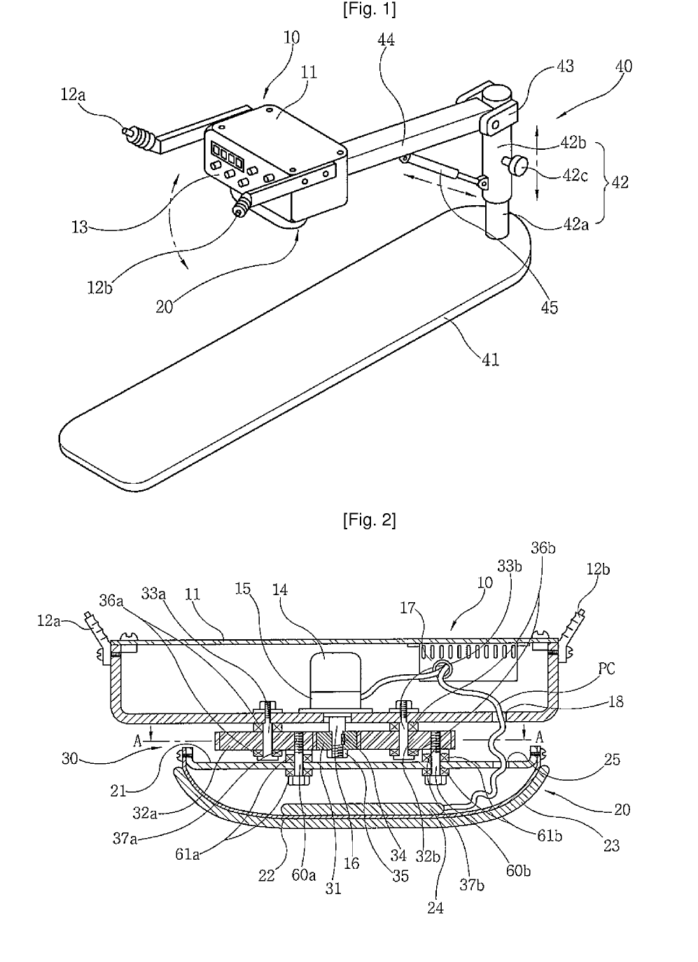

FIG. 1 is a perspective view of a massage apparatus according to a preferred embodiment of the invention and FIG. 2 is a cross-sectional view of the internal structure of a main body and a pressing part of FIG. 1. As seen from FIGS. 1 and 2, a massage apparatus according to the invention includes a main body 10, a pressing part 20, an eccentric-rotating means 30, and a supporting means 40.

The main body 10 includes a box-shaped case 11 of aluminum or plastic. The case 11 has handles 12a and 12b at the left and right upper sides and a control panel 13 mounted at the front, which includes components relating to the operation and control, such as a power switch, a timer, a temperature controller, an operation indicator light, and a micro-computer, etc.

Inside the main body 10, a motor 14, a decelerator 15 decelerating the rotational speed of the motor 14, a driving shaft 16 of the motor 14 passing through the lower surface of the main body 10 protruded with an end portion that is threaded, and a power supply 17 supplying power to the control panel 13, motor 14, and electric heater 24 (described below) are included.

For reference, the motor 14 and the decelerator 15 are separately used in the embodiments of the invention, but a geared motor in which a motor and a decelerator are integrally formed may be used.

The pressing part 20 is formed in a convex shape downward such that it can press a part to be massaged on a human body (e.g. the stomach, the back, or the waist, etc), and includes a lower plate 22 assembled with an upper plate 21, a soft outer cover 23 covering the lower surface of the lower plate 22, and an electric heater 24 mounted on the upper surface of the lower plate 22.

The electric heater 24 is powered by the power supply 17 through a power cable (PC) that passes through a wire hole 18 formed through the case 11 of the main body 10 and a wire hole 25 formed through the upper plate 21 of the pressing part 20 such that it is inserted from the main body 10 to the inside of the pressing part 20.

In this configuration, the power cable (PC) should have sufficient length so as not to interrupt the motion of the pressing part 20, considering that the pressing part 20 moves along a circle (FIG. 3).

The eccentric-rotating means 30 includes a driving gear 31 fitted to the driving shaft 16 of the motor 14, a pair of driven gears 32a and 32b engaged with the driving gear 31 at the opposite sides of the driving gear 31 while having the same size teeth and diameter, and a pair of fixing shafts 33a, 33b rotatably fixing the driven gears 32a and 32b to the case 11 of the main body 10.

In the above configuration, the driving gear 31 is fitted to the driving shaft 16 by well known fasteners, a key 34 and a nut 35, and each of the driven gears 32a and 32b is rotatably connected with the fixing shafts 33a and 33b through bearings 36a and 36b.

Threaded holes 37a and 37b are formed at an eccentric position of the driven gears 32a and 32b about the fixing shaft 33a and 33b, respectively, and a pair of connecting shaft 60a and 60b are thread-fitted in the threaded holes 37a and 37b.

The connecting shafts 60a and 60b pass through the upper plate 21 of the pressing part 20 and the driven gears 32a and 32b so as to connect the pressing part 21 and the driven gears 32a and 32b such that the connecting shafts 60a and 60b run idle through bearings 61a and 61b, and male threads are formed at each upper end portion of the connecting shafts 60a and 60b, which are thread-fitted in the threaded holes 37a and 37b, respectively.

A head is provided at the lower end of each connecting shaft 60a and 60b and may be, for example, a hexagon head bolt integrally formed with one end of the shaft or a nut that is thread-fitted. When a nut is used, male threads are formed at the lower end portion of the connecting shafts 60a and 60b for nut-fitting.

The supporting means 40 includes a base plate 41, a pillar 42 provided at one side of the base plate 41, a hinge 43 provided at the upper end of the pillar 42, an arm 44 whose one end is fixed to the hinge 43 and is pivotable up and down and the other end is connected to the case 11 of the main body 10, a conventional gas lifter 45 whose one end is connected to the pillar 42 and the other end is connected to the arm 44 to support and extend the arm 44 using gas pressure.

The pillar 42 includes first and second pipes 42a and 42b that are assembled such that the pillar 42 can extend/retract up and down and rotates to a left and right, and a fixing bolt 42c that fixes the first pipe 42a to the second pipe 42b by pressing the outer surface of the second pipe 42b with its end passing through the first pipe 42a by threaded fitting.

When the fixing bolt 42c is loosened, the first pipe 42a is released, and the pillar 42 is adjustable in the length up and down and in the position to the left or right. The first pipe 42a is fixed by locking the fixing bolt 42c after the length and position are adjusted.

The operational process of the invention having the above configuration is described below.

A masseur operates the fixing bolt 42c to control the length and left/right position of the pillar 42, and then a user lies down or lies face down on the base plate 41 of the supporting means 40 depending on the parts where the user wants to be given a massage. For example, if the stomach is selected to be massaged, a user lies down, and if the back or the waist is selected to be massaged, the user lies face down.

When a masseur holds the handles of the main body 10 and puts the pressing part 20 on the part of the user to be massaged, the masseur can easily set the height of the main body 10, because the arm 44 connected to the main body 10 is extendible by the gas pressure of the gas lifter 45 supporting the arm 44.

Subsequently, the masseur drives the motor 14 by operating the control panel 13 of the main body 10, and as the driving gear 16 is rotated by the motor 14, the driven gears 32a and 32b are rotated.

Because the driven gears 32a and 32b have the same size teeth and diameter, they rotate in the same direction at the same speed, and the connecting shafts 60a and 60b fitted to the driven gears 32a and 32b also rotate in the same direction at the same speed.

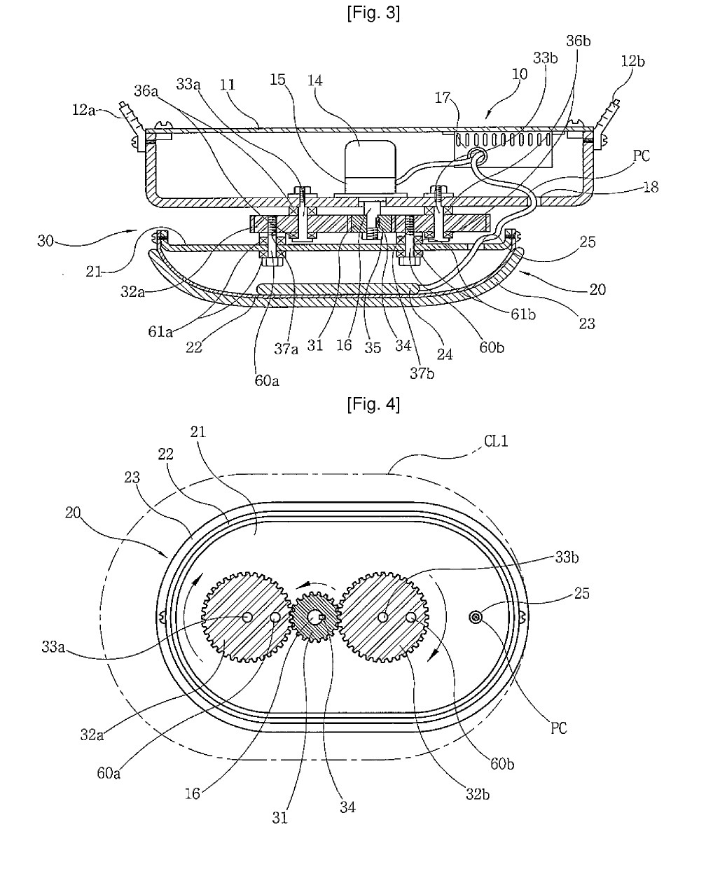

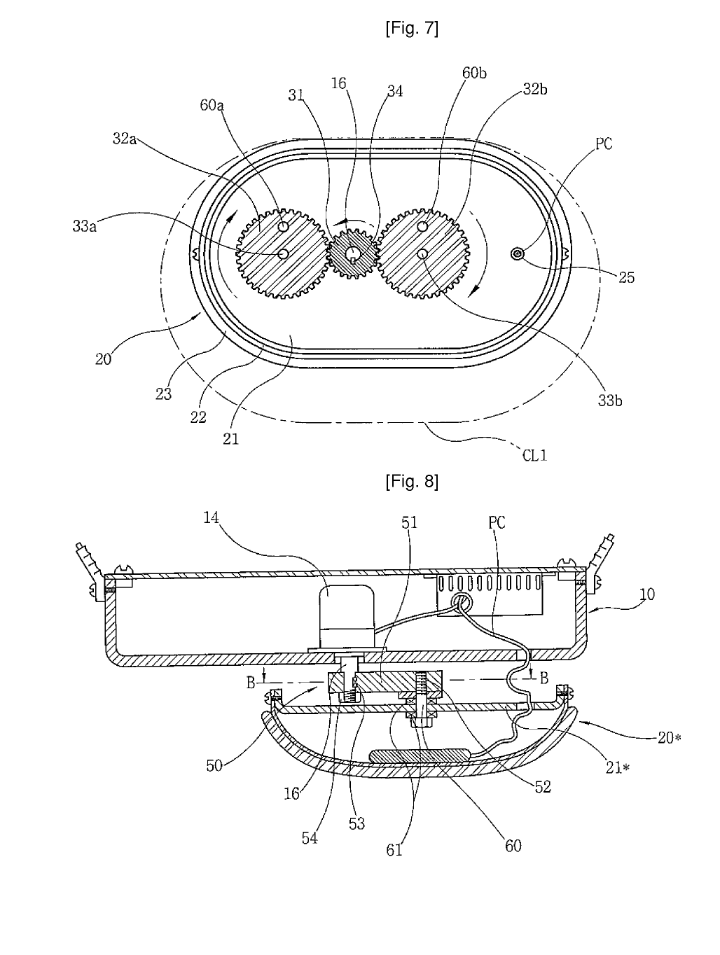

Further, because the connecting shafts 60a and 60b eccentrically rotate about the rotational axes (i.e. the fixing shafts 33a and 33b) and are connected to the pressing part 20 such that they run idle with respect to the pressing part 20, as shown in FIGS. 4 to 7, the pressing part 20 does not rotate, but moves along a circle CL1. As a result, because the user's cloth is not twisted, the user can simply have a massage, even while wearing clothing.

Furthermore, while a massage is given to a region only where the pressing part rotates in the conventional types that the pressing part itself rotates, according to the invention, the pressing part 20 moves within a wide region due to the eccentric rotation of the connecting shaft 60a and 60b, thus massaging a relatively wider area.

In addition, when a masseur powers the electric heater 24 by operating the control panel 13 of the main body 10, a heat massage is possible, because the massaged part is heated by the electric heat generated from the electric heater 24.

If the stomach is given the heat massage, the blood circulation is improved, which can help remove the fat of the stomach. Furthermore, the intestinal motion is activated, thus healing constipation.

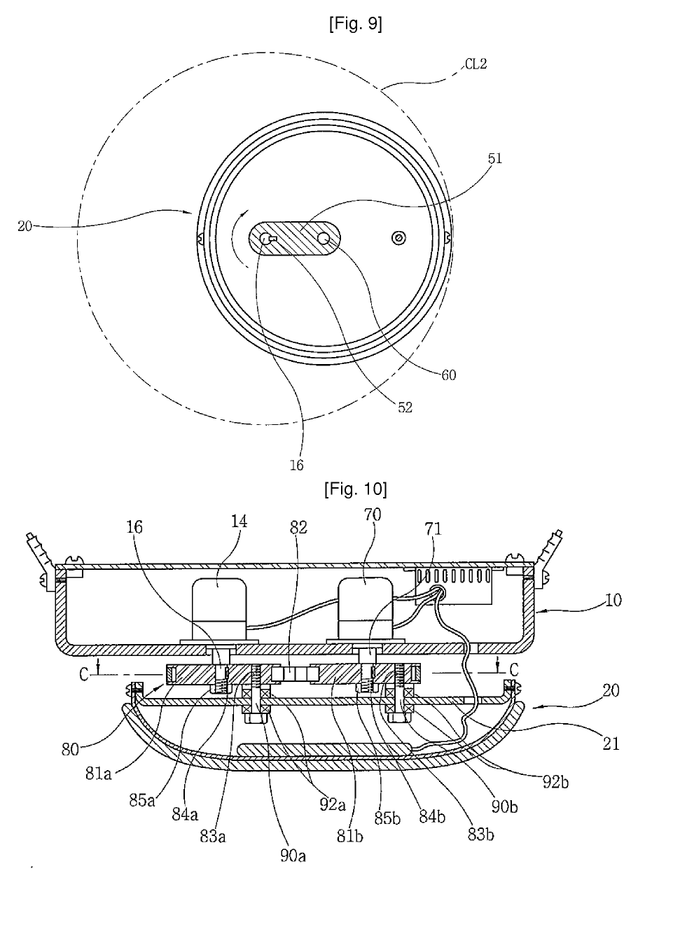

FIG. 8 is a cross-sectional view of a main body and an eccentric-rotating means of a massage apparatus according to another embodiment of the invention and FIG. 9 is a cross-sectional view taken along a line BB of FIG. 8. As seen from FIGS. 8 and 9, according to another embodiment of the invention, an eccentric-rotating means 50 includes a crank arm 51 whose one end is connected with a driving shaft 16 of a motor 14, and a threaded hole 52 formed at the other end of the crank arm 51.

The connecting shaft 60 passes through the upper plate 21* of a pressing part 20* and is connected to the pressing part 20* such that it runs idle through a bearing 61.

Male threads are formed at the upper end portion of the connecting shaft 60, which are thread-fitted in the threaded hole 52 of the other end of the crank arm 51.

A head is provided at the lower end of the connecting shaft 60 and may be, for example, a hexagon head bolt integrally formed with one end of the shaft or a nut that is tread-fitted. When a nut is used, female threads are formed at the lower end portion of the connecting shaft 60 for nut-fitting.

In the eccentric-rotating means 50 according to the above-mentioned another embodiment of the invention configured as described above, when the motor 14 operates, the driving shaft 16 and the crank arm 51 connected with the driving shaft 16 are rotated.

As the crank arm 51 rotates, the connecting shaft 60 eccentrically rotates about a rotational axis (i.e. the driving shaft 16), such that the pressing part 20* moves in a circle CL2.

In this operation, because frictional resistance is generated at the pressing part 20* due to the contact with the massaged part of a user and the connecting shaft 60 runs idle with respect to the pressing part 20*, the pressing part 20* does not rotate, but moves in the circle CL2.

If the pressing part 20* is rotated, it is possible to prevent the pressing part 20* from rotating by fixing its sides to the main body 10 using a fixing member having elasticity and flexibility such as a spring or a rubber band.

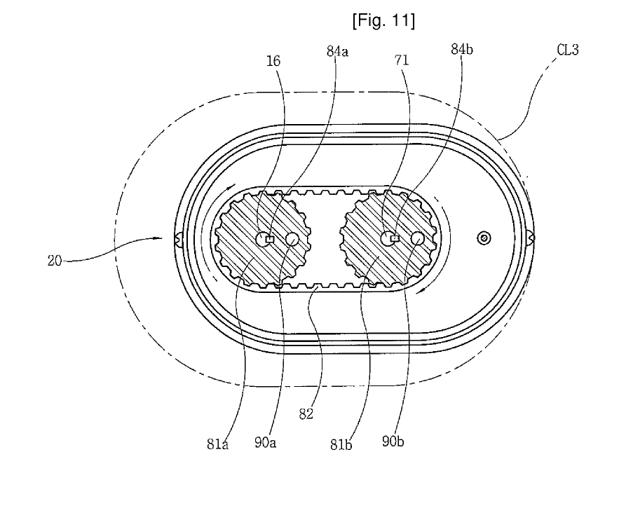

Meanwhile, FIG. 10 is a cross-sectional view of the internal structure of a main body, an eccentric-rotating means, and a pressing part of a massage apparatus according to another embodiment of the invention, and FIG. 11 is a cross-sectional view taken along a line CC of FIG. 10. As seen from FIGS. 10 and 11, according to the above-mentioned another embodiment, a main body 10 further includes a second motor 70, and an eccentric-rotating means 80 includes a pair of driving gears 81a and 81b that have the same size teeth and diameter and are respectively connected with a driving shaft 16 of the motor 14 and a driving shaft 71 of the second motor 70, a time belt 82 that is engaged with the driving gears 81a and 81b to link them, and threaded holes 83a and 83b that are formed at eccentric positions relative to rotational axes (i.e. the driving shafts 16 and 71) of the driving gears 81a and 81b.

The driving gears 81a and 81b are fitted respectively to the driving shafts 16, 71 by conventional keys 84a and 84b and nuts 85a and 85b.

Each connecting shaft 90a and 90b are thread-fitted in the threaded holes 83a and 83b of each driving gear 81a and 81b.

The connecting shafts 90a and 90b pass through the upper plate 21 of a pressing part 20 and are connected to the pressing part 20 such that they run idle through bearings 92a and 92b, and male threads are formed at each upper end portion of the connecting shafts 90a and 90b, which are thread-fitted in the threaded holes 83a and 83b.

A head is provided at the lower end of each connecting shaft 90a and 90b and may be, for example, a hexagon head bolt integrally formed with one end of the shaft, or a nut that is thread-fitted. When a nut is used, male threads are formed at the lower end portions of the connecting shafts 90a and 90b for nut-fitting.

In the eccentric-rotating means 80 according to the above-mentioned another embodiment of the invention configured as described above, when the motors 14 and 70 operate, the driving shafts 16 and 71 and the driving gears fitted to the driving shafts 16 and 71 are rotated.

Even the rotational speeds of the motors 14, 70 are different, because the driving gears 81a and 81b have the same size teeth and diameter and are linked by the timing belt 82, they rotate in the same direction at the same speed and the connecting shafts 90a and 90b fitted to the driving gears rotate in the same direction at the same speed.

Further, because the connecting shafts 90a and 90b eccentrically rotate about rotational axes (i.e. the driving shafts 16 and 71) and are connected to the pressing part 20 such that they run idle with respect to the pressing part, the pressing part 20 itself does not rotate and moves in a circle CL3.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

The invention is particularly useful for a massage for the stomach, but not limited thereto, and may be applied to any part of a human body as long as the part is relatively wide and flat such as the waist and the back, etc.

### TECHNICAL FIELD

The present invention relates to a massage apparatus, and more particularly to a massage apparatus that gives massage effect to the stomach, back, or waist by rubbing.

### BACKGROUND ART

In the related art, a hitting-type massage apparatus that hits at the target and a vibrating-type massage apparatus that vibrates under pressure are known as massage apparatuses, in particular, stomach massage apparatuses intended for massaging the stomach.

Since the above-mentioned hitting-type and vibrating type massage apparatuses give continuous massages by applying hitting or vibrating motion to only a specific contacting part, a user may feel pain in the massaged parts, especially in the bones, when the hitting or vibration is excessive.

Accordingly, in the related art, a cam-type stomach massage apparatus that presses and rubs the stomach has been developed to overcome the above problems, in which an inclined cam is connected to a driving shaft and rotated, and as the inclined cam rotates, a pressing plate rotating at an angle massages the stomach.

### DISCLOSURE OF INVENTION

### Technical Problem

According to the above-mentioned cam-type stomach massage apparatus, however, because the pressing plate itself rotates, the article of clothing is twisted in the rotational direction of the pressing plate. Accordingly, a user wearing clothing cannot receive a massage, and continuous massages are given only to a specific part in the region where the cam rotates as the hitting-type and vibrating-type massage apparatuses, such that it is difficult to effectively give a massage.

The invention has been finalized in order to solve the above problems, and it is an object of the invention to provide a massage apparatus that is capable of effectively massaging a user wearing clothing and widely massages a wide region without a pain in the specific part.

### Technical Solution

In order to accomplish the above objects, according to an aspect of the invention, a massage apparatus includes a main body including a motor, a supporting means movably supporting the main body, a pressing part mounted under the main body to get in contact with a part of a human body to be massaged, an eccentric-rotating means connected with a driving shaft of the motor to eccentrically rotate a connecting shaft connected with the pressing part, and a connecting part connecting the connecting shafts of the eccentric-rotating means to the upper portion of the pressing part such that the connecting shafts run idle.

According to the aspect of the invention, the connecting shafts may be provided in a pair, and the eccentric-rotating means may include a driving gear fitted to the driving shaft of the motor, a pair of driven gears that are engaged with the driving gear so as to face each other and have the same teeth and diameter, a pair of fixing shafts rotatably fixing the pair of driven gears under the main body, respectively, and a pair of connecting parts fitting the connecting shafts at each eccentric position relative to the fixing shafts of the respective driven gears.

According to another aspect of the invention, the eccentric-rotating means may include a crank arm whose one end is connected to the driving shaft of the motor and a pair of connecting parts connecting the connecting shafts to the other end of the crank arm, respectively.

According to another aspect of the invention, the connecting shaft is provided in a pair, the main body may include a pair of motors, and the eccentric-rotating means may include a pair of driving gears that are fitted to driving shafts of the motors, respectively, and have the same teeth and diameter, a time belt engaged with the driving gears so as to be linked with each other, and a pair of connecting parts fitting the connecting shafts to the respective driving gears at each eccentric position relative to the driving shafts of the motors.

### ADVANTAGEOUS EFFECTS

According to a stomach heating massage apparatus of the invention, a pressing part that gets in contact with a part to be massaged does not rotate and moves in a circle, such that a user wearing clothing can simply use the massage apparatus in a public place, such as a gym, or at home, as the clothing is not twisted, thereby giving an effective massage, and increasing the massage region.

According to an embodiment of the invention, since a pressing part rubs the part to be massaged while keeping warmth of the pressing part by an electric heater, when the stomach is massaged, the blood circulation is improved and the fat of the stomach can be removed. Furthermore, the intestinal motion is activated, thus healing constipation.

Further, according to another embodiment of the invention, because a main body and a pressing part are supported by a movable supporting means, a user can easily control the pressing force against the part to be massaged, such as the stomach, etc., without applying excessive pressing on the stomach by oneself.

### BRIEF DESCRIPTION OF THE DRAWINGS

FIG. 1 is a perspective view of a massage apparatus according to a preferred embodiment of the invention;

FIG. 2 is a cross-sectional view of the internal structure of a main body and pressing part of FIG. 1;

FIG. 3 is a cross-sectional view of FIG. 2 after the pressing part moves;

FIG. 4 is a cross-sectional view taken along a line AA of FIG. 2;

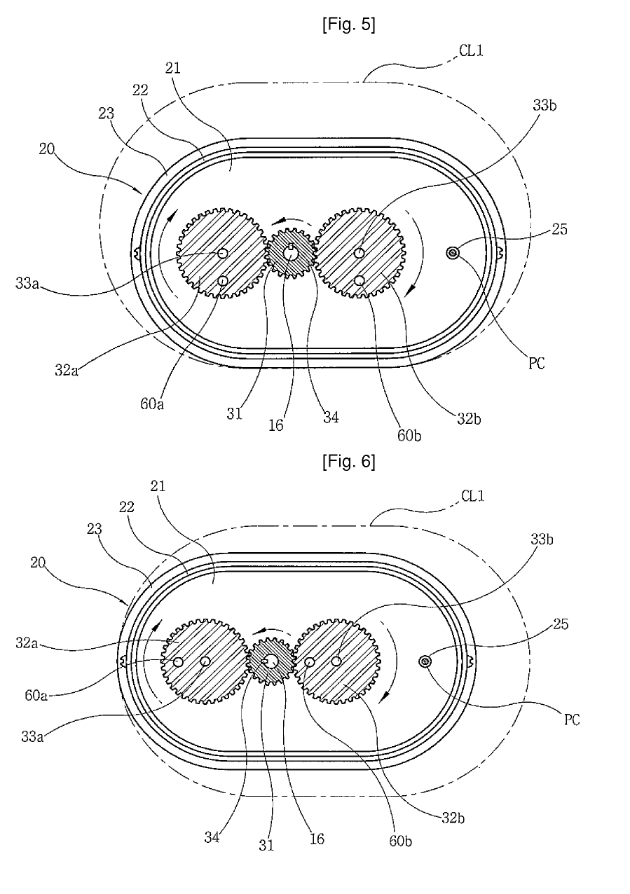

FIGS. 5 to 7 are views of FIG. 4 after the pressing part moves;

FIG. 8 is a cross-sectional view of the internal structure of a main body, eccentric-rotating means, and pressing part of a massage apparatus according to another embodiment of the invention;

FIG. 9 is a cross-sectional view taken along a line BB of FIG. 8;

FIG. 10 is a cross-sectional view of the internal structure of a main body, eccentric-rotating means, and pressing part of a massage apparatus according to another embodiment of the invention; and

FIG. 11 is a cross-sectional view taken along a line CC of FIG. 10.

### MODE FOR THE INVENTION

Preferred embodiments of the invention are described hereafter with reference to the accompanying drawings.

FIG. 1 is a perspective view of a massage apparatus according to a preferred embodiment of the invention and FIG. 2 is a cross-sectional view of the internal structure of a main body and a pressing part of FIG. 1. As seen from FIGS. 1 and 2, a massage apparatus according to the invention includes a main body 10, a pressing part 20, an eccentric-rotating means 30, and a supporting means 40.

The main body 10 includes a box-shaped case 11 of aluminum or plastic. The case 11 has handles 12a and 12b at the left and right upper sides and a control panel 13 mounted at the front, which includes components relating to the operation and control, such as a power switch, a timer, a temperature controller, an operation indicator light, and a micro-computer, etc.

Inside the main body 10, a motor 14, a decelerator 15 decelerating the rotational speed of the motor 14, a driving shaft 16 of the motor 14 passing through the lower surface of the main body 10 protruded with an end portion that is threaded, and a power supply 17 supplying power to the control panel 13, motor 14, and electric heater 24 (described below) are included.

For reference, the motor 14 and the decelerator 15 are separately used in the embodiments of the invention, but a geared motor in which a motor and a decelerator are integrally formed may be used.

The pressing part 20 is formed in a convex shape downward such that it can press a part to be massaged on a human body (e.g. the stomach, the back, or the waist, etc), and includes a lower plate 22 assembled with an upper plate 21, a soft outer cover 23 covering the lower surface of the lower plate 22, and an electric heater 24 mounted on the upper surface of the lower plate 22.

The electric heater 24 is powered by the power supply 17 through a power cable (PC) that passes through a wire hole 18 formed through the case 11 of the main body 10 and a wire hole 25 formed through the upper plate 21 of the pressing part 20 such that it is inserted from the main body 10 to the inside of the pressing part 20.

In this configuration, the power cable (PC) should have sufficient length so as not to interrupt the motion of the pressing part 20, considering that the pressing part 20 moves along a circle (FIG. 3).

The eccentric-rotating means 30 includes a driving gear 31 fitted to the driving shaft 16 of the motor 14, a pair of driven gears 32a and 32b engaged with the driving gear 31 at the opposite sides of the driving gear 31 while having the same size teeth and diameter, and a pair of fixing shafts 33a, 33b rotatably fixing the driven gears 32a and 32b to the case 11 of the main body 10.

In the above configuration, the driving gear 31 is fitted to the driving shaft 16 by well known fasteners, a key 34 and a nut 35, and each of the driven gears 32a and 32b is rotatably connected with the fixing shafts 33a and 33b through bearings 36a and 36b.

Threaded holes 37a and 37b are formed at an eccentric position of the driven gears 32a and 32b about the fixing shaft 33a and 33b, respectively, and a pair of connecting shaft 60a and 60b are thread-fitted in the threaded holes 37a and 37b.

The connecting shafts 60a and 60b pass through the upper plate 21 of the pressing part 20 and the driven gears 32a and 32b so as to connect the pressing part 21 and the driven gears 32a and 32b such that the connecting shafts 60a and 60b run idle through bearings 61a and 61b, and male threads are formed at each upper end portion of the connecting shafts 60a and 60b, which are thread-fitted in the threaded holes 37a and 37b, respectively.

A head is provided at the lower end of each connecting shaft 60a and 60b and may be, for example, a hexagon head bolt integrally formed with one end of the shaft or a nut that is thread-fitted. When a nut is used, male threads are formed at the lower end portion of the connecting shafts 60a and 60b for nut-fitting.

The supporting means 40 includes a base plate 41, a pillar 42 provided at one side of the base plate 41, a hinge 43 provided at the upper end of the pillar 42, an arm 44 whose one end is fixed to the hinge 43 and is pivotable up and down and the other end is connected to the case 11 of the main body 10, a conventional gas lifter 45 whose one end is connected to the pillar 42 and the other end is connected to the arm 44 to support and extend the arm 44 using gas pressure.

The pillar 42 includes first and second pipes 42a and 42b that are assembled such that the pillar 42 can extend/retract up and down and rotates to a left and right, and a fixing bolt 42c that fixes the first pipe 42a to the second pipe 42b by pressing the outer surface of the second pipe 42b with its end passing through the first pipe 42a by threaded fitting.

When the fixing bolt 42c is loosened, the first pipe 42a is released, and the pillar 42 is adjustable in the length up and down and in the position to the left or right. The first pipe 42a is fixed by locking the fixing bolt 42c after the length and position are adjusted.

The operational process of the invention having the above configuration is described below.

A masseur operates the fixing bolt 42c to control the length and left/right position of the pillar 42, and then a user lies down or lies face down on the base plate 41 of the supporting means 40 depending on the parts where the user wants to be given a massage. For example, if the stomach is selected to be massaged, a user lies down, and if the back or the waist is selected to be massaged, the user lies face down.

When a masseur holds the handles of the main body 10 and puts the pressing part 20 on the part of the user to be massaged, the masseur can easily set the height of the main body 10, because the arm 44 connected to the main body 10 is extendible by the gas pressure of the gas lifter 45 supporting the arm 44.

Subsequently, the masseur drives the motor 14 by operating the control panel 13 of the main body 10, and as the driving gear 16 is rotated by the motor 14, the driven gears 32a and 32b are rotated.

Because the driven gears 32a and 32b have the same size teeth and diameter, they rotate in the same direction at the same speed, and the connecting shafts 60a and 60b fitted to the driven gears 32a and 32b also rotate in the same direction at the same speed.

Further, because the connecting shafts 60a and 60b eccentrically rotate about the rotational axes (i.e. the fixing shafts 33a and 33b) and are connected to the pressing part 20 such that they run idle with respect to the pressing part 20, as shown in FIGS. 4 to 7, the pressing part 20 does not rotate, but moves along a circle CL1. As a result, because the user's cloth is not twisted, the user can simply have a massage, even while wearing clothing.

Furthermore, while a massage is given to a region only where the pressing part rotates in the conventional types that the pressing part itself rotates, according to the invention, the pressing part 20 moves within a wide region due to the eccentric rotation of the connecting shaft 60a and 60b, thus massaging a relatively wider area.

In addition, when a masseur powers the electric heater 24 by operating the control panel 13 of the main body 10, a heat massage is possible, because the massaged part is heated by the electric heat generated from the electric heater 24.

If the stomach is given the heat massage, the blood circulation is improved, which can help remove the fat of the stomach. Furthermore, the intestinal motion is activated, thus healing constipation.

FIG. 8 is a cross-sectional view of a main body and an eccentric-rotating means of a massage apparatus according to another embodiment of the invention and FIG. 9 is a cross-sectional view taken along a line BB of FIG. 8. As seen from FIGS. 8 and 9, according to another embodiment of the invention, an eccentric-rotating means 50 includes a crank arm 51 whose one end is connected with a driving shaft 16 of a motor 14, and a threaded hole 52 formed at the other end of the crank arm 51.

The connecting shaft 60 passes through the upper plate 21* of a pressing part 20* and is connected to the pressing part 20* such that it runs idle through a bearing 61. Male threads are formed at the upper end portion of the connecting shaft 60, which are thread-fitted in the threaded hole 52 of the other end of the crank arm 51.

A head is provided at the lower end of the connecting shaft 60 and may be, for example, a hexagon head bolt integrally formed with one end of the shaft or a nut that is tread-fitted. When a nut is used, female threads are formed at the lower end portion of the connecting shaft 60 for nut-fitting.

In the eccentric-rotating means 50 according to the above-mentioned another embodiment of the invention configured as described above, when the motor 14 operates, the driving shaft 16 and the crank arm 51 connected with the driving shaft 16 are rotated.

As the crank arm 51 rotates, the connecting shaft 60 eccentrically rotates about a rotational axis (i.e. the driving shaft 16), such that the pressing part 20* moves in a circle CL2.

In this operation, because frictional resistance is generated at the pressing part 20* due to the contact with the massaged part of a user and the connecting shaft 60 runs idle with respect to the pressing part 20*, the pressing part 20* does not rotate, but moves in the circle CL2.

If the pressing part 20* is rotated, it is possible to prevent the pressing part 20* from rotating by fixing its sides to the main body 10 using a fixing member having elasticity and flexibility such as a spring or a rubber band.

Meanwhile, FIG. 10 is a cross-sectional view of the internal structure of a main body, an eccentric-rotating means, and a pressing part of a massage apparatus according to another embodiment of the invention, and FIG. 11 is a cross-sectional view taken along a line CC of FIG. 10. As seen from FIGS. 10 and 11, according to the above-mentioned another embodiment, a main body 10 further includes a second motor 70, and an eccentric-rotating means 80 includes a pair of driving gears 81a and 81b that have the same size teeth and diameter and are respectively connected with a driving shaft 16 of the motor 14 and a driving shaft 71 of the second motor 70, a time belt 82 that is engaged with the driving gears 81a and 81b to link them, and threaded holes 83a and 83b that are formed at eccentric positions relative to rotational axes (i.e. the driving shafts 16 and 71) of the driving gears 81a and 81b.

The driving gears 81a and 81b are fitted respectively to the driving shafts 16, 71 by conventional keys 84a and 84b and nuts 85a and 85b.

Each connecting shaft 90a and 90b are thread-fitted in the threaded holes 83a and 83b of each driving gear 81a and 81b.

The connecting shafts 90a and 90b pass through the upper plate 21 of a pressing part 20 and are connected to the pressing part 20 such that they run idle through bearings 92a and 92b, and male threads are formed at each upper end portion of the connecting shafts 90a and 90b, which are thread-fitted in the threaded holes 83a and 83b.

A head is provided at the lower end of each connecting shaft 90a and 90b and may be, for example, a hexagon head bolt integrally formed with one end of the shaft, or a nut that is thread-fitted. When a nut is used, male threads are formed at the lower end portions of the connecting shafts 90a and 90b for nut-fitting.

In the eccentric-rotating means 80 according to the above-mentioned another embodiment of the invention configured as described above, when the motors 14 and 70 operate, the driving shafts 16 and 71 and the driving gears fitted to the driving shafts 16 and 71 are rotated.

Even the rotational speeds of the motors 14, 70 are different, because the driving gears 81a and 81b have the same size teeth and diameter and are linked by the timing belt 82, they rotate in the same direction at the same speed and the connecting shafts 90a and 90b fitted to the driving gears rotate in the same direction at the same speed.

Further, because the connecting shafts 90a and 90b eccentrically rotate about rotational axes (i.e. the driving shafts 16 and 71) and are connected to the pressing part 20 such that they run idle with respect to the pressing part, the pressing part 20 itself does not rotate and moves in a circle CL3.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

The invention is particularly useful for a massage for the stomach, but not limited thereto, and may be applied to any part of a human body as long as the part is relatively wide and flat such as the waist and the back, etc.

1. A massage apparatus, comprising:
a main body including a motor;
a supporting means movably supporting the main body;
a pressing part mounted under the main body to get in contact with a part of a human body to be massaged;
an eccentric-rotating means connected with a driving shaft of the motor to eccentrically rotate a connecting shaft connected with the pressing part; and
a connecting part connecting the connecting shaft of the eccentric-rotating means to the upper portion of the pressing part such that the connecting shaft runs idle.

2. The massage apparatus as set forth in claim 1, wherein the connecting shaft is provided in a pair, and
the eccentric-rotating means includes:
a driving gear fitted to the driving shaft of the motor;
a pair of driven gears that are engaged with the driving gear so as to face each other and have the same size teeth and diameter;
a pair of fixing shafts rotatably fixing the pair of driven gears under the main body, respectively; and
a pair of connecting parts fitting the pair of connecting shafts respectively at each eccentric position relative to the fixing shafts of the respective driven gears.

3. The massage apparatus as set forth in claim 2, wherein the pair of connecting parts includes:
male threads formed on the periphery of the connecting shafts; and
threaded holes that are formed at eccentric positions relative to the fixing shafts of the respective driven gears and in which female threads corresponding to the male threads of the connecting shafts are formed at the inner circumferences thereof.

4. The massage apparatus as set forth in claim 1, wherein the eccentric-rotating means includes:
a crank arm whose one end is connected to the driving shaft of the motor; and
a pair of connecting parts connecting the connecting shafts to the other end of the crank arm, respectively.

5. The massage apparatus as set forth in claim 4, wherein the pair of connecting part including:
male threads formed on the periphery of the connecting shafts; and
threaded holes that are formed at the other end of the crank arm and in which female threads corresponding to the male threads of the connecting shafts are formed at the inner circumferences of thereof.

6. The massage apparatus as set forth in claim 1, wherein the connecting shaft is provided in a pair,
the main body includes a pair of motors, and
the eccentric-rotating means includes:
a pair of driving gears that are fitted to driving shafts of the pair of motors, respectively, and have the same size teeth and diameter;
a time belt engaged with the pair of driving gears so as to be linked with each other; and
a pair of connecting parts fitting the connecting shafts respectively to the respective driving gears at each eccentric position relative to the driving shafts of the motors.

7. The massage apparatus as set forth in claim 6, wherein the pair of connecting parts includes:
male threads formed on the periphery of the connecting shafts; and
threaded holes that are formed in the respective driving gears at eccentric position relative to the driving shafts of the motors and in which female threads corresponding to the male threads are formed at the inner circumferences thereof.

8. The massage apparatus as set forth in claim 1, wherein the pressing part includes:
an upper plate;
a lower plate that is formed convex downward to press the part of the human body to be massaged and assembled with the upper plate; and
a soft cover covering a lower surface of the lower plate.

9. The massage apparatus as set forth in claim 1, wherein the pressing part further includes an electric heater mounted on an upper surface of the lower plate.

10. The massage apparatus as set forth in claim 1, wherein the supporting means includes:
a pillar;
a hinge mounted on an upper end of the pillar;
an arm whose one end is fixed to the hinge so as to be fixed rotatable up and down and the other end is connected to the main body; and
a gas lifter of which one end is connected to an end of the pillar and the other end is connected to the arm so as to support extensibly the arm by gas pressure.

11. The massage apparatus as set forth in claim 10, wherein the pillar of the supporting means includes:
first and second pipes assembled such that the pipes are extensible up and down and rotatable left and right; and
a fixing bolt passing through a side of the first pipe to fix the first pipe to the second pipe by pressing the outer surface of the second pipe with the end thereof.

12. The massage apparatus as set forth in claim 1, wherein handles are attached to the main body so as to easily hold the handles.
